(19) United States
(12) Patent Application Publication
(10) Pub. No.: US 2019/0247685 A1
(43) Pub. Date: Aug. 15, 2019

(54) FIREPROOF COVER UTILIZING THERMAL INSULATION LAYERS

(71) Applicant: Eaton Intelligent Power Limited, Dublin 4 (IE)

(72) Inventors: Amit A. Kolte, Pune (IN); Dipak B. Ranaware, Pune (IN)

(21) Appl. No.: 16/267,720

(22) Filed: Feb. 5, 2019

Related U.S. Application Data
(60) Provisional application No. 62/630,387, filed on Feb. 14, 2018.

(51) Int. Cl. A62C 2/06

(52) U.S. Cl. CPC A62C 2/06

(57) ABSTRACT

A fireproof cover for fluid conveyance products includes an inner layer including a first polymer, an intermediate layer including a thermally insulating material, and an outer layer including a second polymer. One or more additional intermediate layers may be disposed at least partially between the inner layer and the outer layer. The intermediate layer may include fiberglass and may be disposed around the inner layer. The one or more additional intermediate layers may include (i) a first layer of basalt tape wrapped around the intermediate layer, (ii) a layer of fiberglass wrapped around the first layer of basalt tape, and (iii) a second layer of basalt tape wrapped around the layer of fiberglass. The outer layer may be disposed at an outer surface of the second layer of basalt tape.

### CROSS-REFERENCE TO RELATED APPLICATION

This application claims the benefit of U.S. Provisional Patent Application Ser. No. 62/630,387, filed on Feb. 14, 2018, the disclosure of which is hereby incorporated herein by reference in its entirety.

### TECHNICAL FIELD

The present disclosure generally relates to fluid conduits and fireproof covers that may be used in connection therewith, such as in aerospace applications.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Fluid conveyance products, such as conduits, hoses, fittings, couplings, and tubes, may be used in locations exposed to fire. In such applications, a fire protection mechanism may be utilized to ensure that the product does not fail (e.g., leak) within a specified duration of time (e.g., 5 to 15 minutes) under specified conditions. Some fire protection technologies include integral silicone covers and silicone-coated fiberglass sleeves.

In aerospace applications, as aircraft systems have evolved, fire test requirements have become more severe, posing challenges in demonstrating compliance with existing fireproofing technologies. For example, some current fireproof covers may not consistently meet AS1055 and TSO fire performance requirements that permit some flow of fluid through the fluid conveying product during testing, let alone AS1055 no-flow requirements demanded of next-generation fluid conveying products.

There is a desire for solutions/options that minimize or eliminate one or more challenges or shortcomings of fluid conveyance products, such as to meet more stringent no-flow requirements. The foregoing discussion is intended only to illustrate examples of the present field and should not be taken as a disavowal of scope.

### SUMMARY

In embodiments, a fireproof cover for fluid conveyance products may include an inner layer including a first polymer, an intermediate layer including a thermally insulating material, and/or an outer layer including a second polymer. The first polymer and/or the second polymer may include silicone. The first polymer and the second polymer may or may not be the same. One or more additional intermediate layers may be disposed at least partially between the inner layer and the outer layer. The intermediate layer may include fiberglass and may be disposed around the inner layer. The one or more additional intermediate layers may include (i) a first layer of basalt tape wrapped around the intermediate layer, (ii) a layer of fiberglass wrapped around the first layer of basalt tape, and (iii) a second layer of basalt tape wrapped around the layer of fiberglass. The outer layer may be disposed at an outer surface of the second layer of basalt tape.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is a cross-sectional view generally illustrating embodiments of a fluid coupling, a fluid conduit, a cover, and a second fluid conduit according to teachings of the present disclosure.

FIG. 2 is a cross-sectional view generally illustrating portions of embodiments of a fluid conduit and a cover according to teachings of the present disclosure.

FIG. 3 is a cross-sectional view generally illustrating portions of an embodiment of a cover and a fluid conduit according to teachings of the present disclosure.

FIG. 4 is a cross-sectional view generally illustrating portions of an embodiment of a cover and a fluid conduit according to teachings of the present disclosure.

FIG. 5 is a flow chart generally illustrating an embodiment of a method of forming a cover according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they are not intended to limit the present disclosure to these embodiments and/or examples. On the contrary, the present disclosure is intended to cover alternatives, modifications, and equivalents.

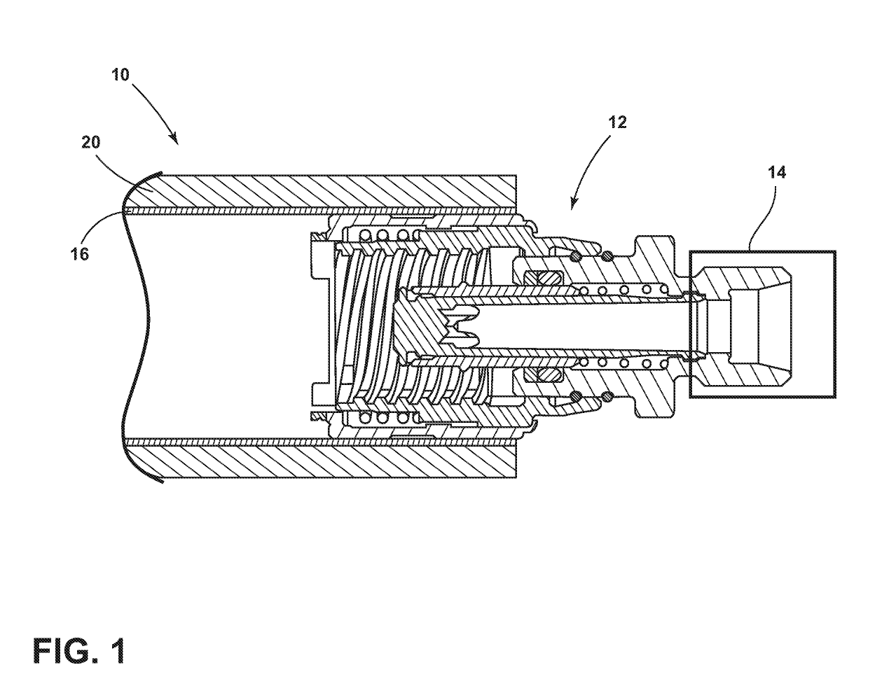

In embodiments, such as generally illustrated in FIG. 1, a fluid conduit assembly 10 may be connected to a fluid coupling 12. The fluid coupling 12 may be configured to connect the fluid conduit assembly 10 with a second fluid conduit assembly 14. The fluid coupling 12 may, for example and without limitation, be configured as a quick-disconnect coupling.

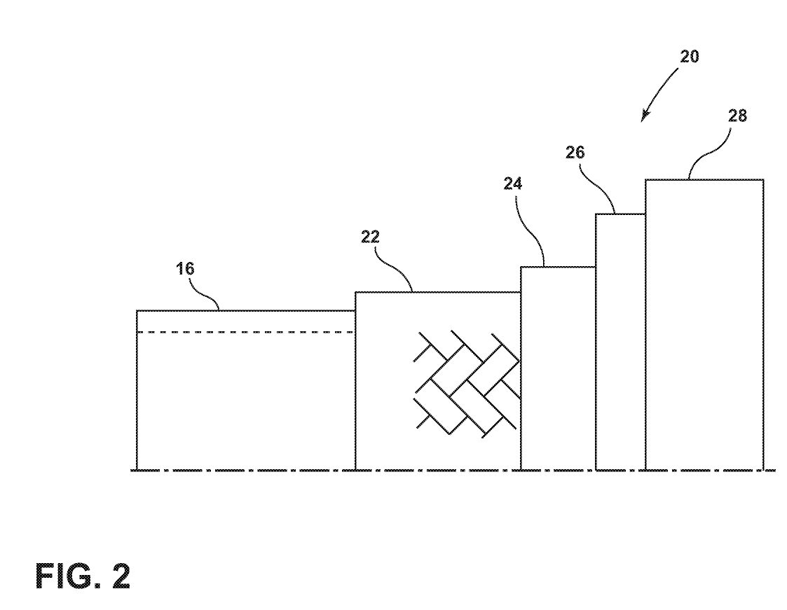

With embodiments, such as generally illustrated in FIGS. 1 and 2, the fluid conduit assembly 10 may include a fluid conduit 16 (or fluid conveyance product) and a cover 20 (e.g., a fireproof cover). The fluid conduit 16 may include, for example and without limitation, polytetrafluoroethylene (PTFE). The fluid conduit 16 may be configured for use with one or more of a variety of fluids, such as, for example and without limitation, hydraulic fluid and/or aircraft fuel. The cover 20 and/or the fluid conduit 16 may cover and/or thermally insulate at least a portion of a fluid coupling 12 (see, e.g., FIG. 1).

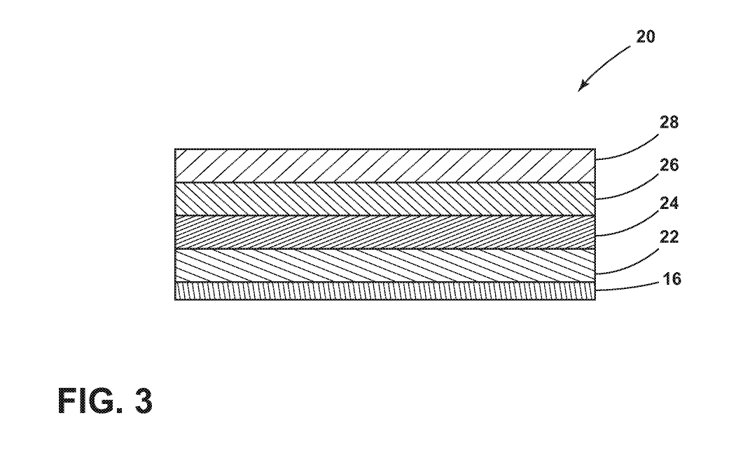

In embodiments, such as generally illustrated in FIGS. 2 and 3, a cover 20 may include a plurality of layers, such as a first layer 22, a second layer 24, a third layer 26, and/or a fourth layer 28. The first layer 22 may be configured as an inner layer that may be connected to a fluid conduit 16. The fourth layer 28 may be configured as an outer layer that may be exposed to the environment. The second layer 24 and/or the third layer 26 may be configured as intermediate layers that may be disposed at least partially between the first layer 22 and the fourth layer 28. One or more of the layers may be configured as thermal insulation layers. For example and without limitation, the intermediate layers 24, 26 may be configured as thermal insulation layers. In embodiments, one or more of the layers 22, 24, 26, 28 may include fire protective material integrated with a polymer medium. The fire protective material may comprise, but is not limited to, a yarn, tape, and/or sleeve. The polymer medium may comprise, but is not limited to, plastics, silicone, fluorosilicone, rubber, thermoplastic materials, and/or elastomeric materials, among others.

In embodiments, the intermediate layers 24, 26 may include fire retardant material and may be provided over the inner layer 22 (e.g., a polymer layer) to provide superior fire protection properties over traditional flame-retardant materials. When subjected to high heat, the fire-retardant material(s) may decompose to form water molecules and/or may flake out in an endothermic reaction, which may be more resistant to degradation than typical intumescent materials.

With embodiments, the cover 20 may, for example, be extruded or molded directly over a base product (e.g., a fluid conduit 16), such as for some or all applications that are subject to AS1055 fireproof requirements. Additionally or alternatively, a cover 20 could be connected with a fluid conduit 16 separately, such as in the form of a sleeve or shield.

In an embodiment shown in FIG. 2, the inner layer 22 of the cover 20 may include a molded silicone base layer. The first intermediate layer 24 may be silica sleeve that may be applied at least partially over the inner layer 22. A second intermediate layer 26 may be provided at least partially over the first intermediate layer 24. The second intermediate layer 26 may include basalt. The second intermediate layer 26 may be provided as a basalt yarn or tape that may be woven, wrapped, and/or otherwise applied over the first intermediate layer 24. An outer layer 28 may be disposed over the second intermediate layer 26. The outer layer 28 may include silicone. The outer layer 28 may be molded and/or extruded at least partially around the second intermediate layer 26. A radius of the inner layer 22 may be smaller than a radius of the outer layer 28.

In embodiments, the intermediate layers 24, 26 (e.g., thermal insulation layers) may include different fire-resistant yarns, sleeves, and/or tapes with fire retardant material like expandable graphite or alumina trihydrate (ATH), magnesium hydroxide (MDH), and/or engineered molybdate compounds over or under silicone layers (e.g., the inner and outer layers 22, 28).

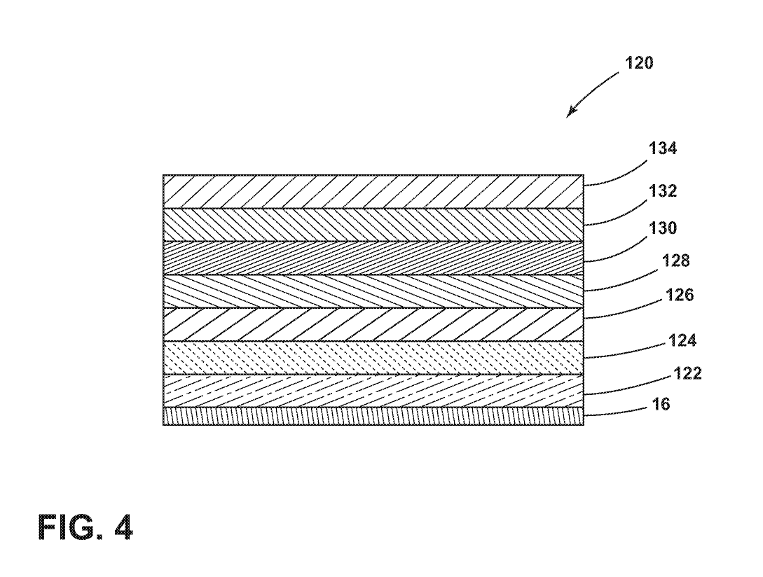

With embodiments, such as generally illustrated in FIG. 4, a fireproof cover 120 may include a plurality of layers, such as a first layer 122, a second layer 124, a third layer 126, a fourth layer 128, a fifth layer 130, a sixth layer 132, and/or a seventh layer 134.

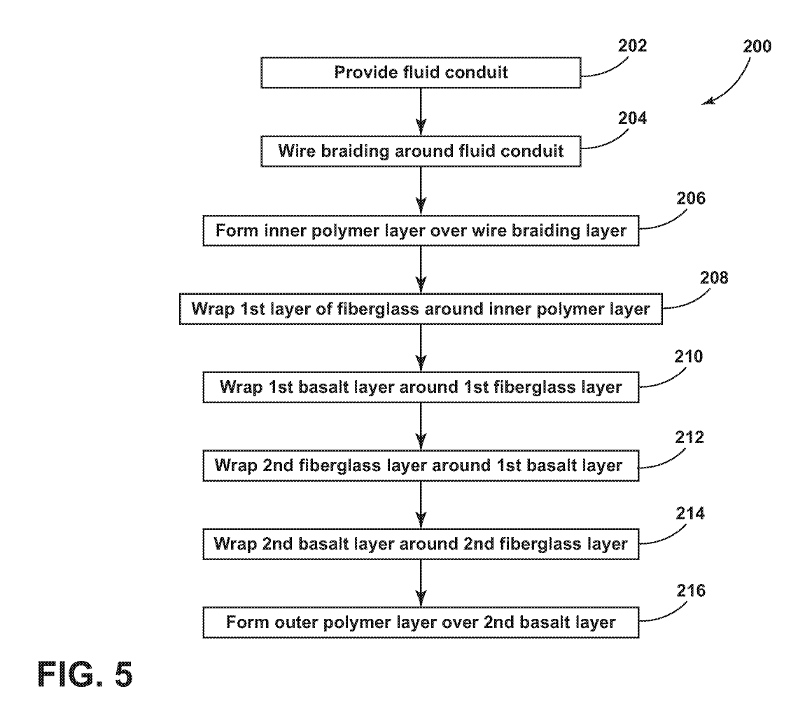

In embodiments, such as generally illustrated in FIG. 5, a method 200 of forming a fireproof cover 120 may include providing a fluid conduit 16 (step 202). The fluid conduit 16 may, for example and without limitation, include an outer diameter of about 0.5 inches, such as about 0.521 inches. A first layer 122 may be formed/provided around the fluid conduit 16 (step 204). The first layer 122 may include wire braiding that may be braided with a predefined tension. The first layer 122 may be disposed in contact with an outer surface of the fluid conduit 16. The first layer 122 may, for example and without limitation, include a thickness of about 0.03 inches, such as about 0.032 inches. The wire braiding may include corrosion-resistant steel (CRES) and/or stainless steel.

With embodiments, a second layer 124 may be provided/formed, such as extruded and/or molded around the first layer (step 206). The second layer 124 may include a polymer such as silicone. The second layer 124 may, for example and without limitation, include a thickness of about 0.13 inches, such as about 0.135 inches.

In embodiments, a third layer 126 may be provided/formed (step 208), such as at least partially around the second layer 124. The third layer 126 may include fiberglass and/or wire braiding. The third layer 126 may be provided as a tape and may be wound/wrapped around the second layer 124. The third layer 126 may, for example and without limitation, include a thickness of about 0.03 inches, such as about 0.032 inches.

With embodiments, a fourth layer 128 may be provided/formed (step 210), such as at least partially around the third layer 126. The fourth layer 128 may include basalt. The fourth layer 128 may be provided as a tape and may be wound/wrapped around the third layer 126. The fourth layer 128 may, for example and without limitation, include a thickness of about 0.08 inches, such as about 0.0785 inches.

In embodiments, a fifth layer 130 may be provided/formed (step 212), such as at least partially around the fourth layer 128. The fifth layer 130 may include fiberglass and/or wire braiding. The fifth layer 130 may be provided as a tape and may be wound/wrapped around the fourth layer 128. The fifth layer 130 may, for example and without limitation, include a thickness of about 0.016 inches, such as about 0.0158 inches.

With embodiments, a sixth layer 132 may be provided/formed (step 214), such as at least partially around the fifth layer 130. The sixth layer 132 may include basalt. The sixth layer 132 may be provided as a yarn and may be braided with a predefined tension. The sixth layer 132 may be disposed around and/or in contact with an outer surface of the fifth layer 130. The sixth layer 132 may, for example and without limitation, include a thickness of about 0.03 inches, such as about 0.027 inches.

In embodiments, a seventh layer 134 may be provided/formed (step 216), such as at least partially around the sixth layer 132. The seventh layer 134 may include a polymer such as silicone. The seventh layer 134 may be extruded and/or molded around the sixth layer 132. The seventh layer 134 may be an exterior layer and/or an outer surface of the seventh layer 134 may be exposed to the environment. One or more of the other layers (e.g., layers 122, 124, 126, 128, 130, 132) may be partially or completely covered by another layer or a plurality of layers. The seventh layer 134 may, for example and without limitation, include a thickness of about 0.08 inches. An outer diameter of the cover 120, which may include seven layers, and the fluid conduit 16 may be about 1.3 inches, such as about 1.2896 inches.

With embodiments, a total thickness of a cover 20, 120 may, for example and without limitation, be about 0.4 inches. The thickness of a cover 20, 120 may, for example and without limitation, be greater than half of the diameter of the fluid conduit 16 and/or may be less than the diameter of the fluid conduit 16.

In embodiments, the second layer 124 may be referred to as an inner layer, the seventh layer 134 may be referred to as an outer layer, and/or the third layer 126, the fourth layer 128, the fifth layer 130, and/or the sixth layer 132 may be referred to as intermediate layers. The intermediate layers 126, 128, 130, 132 may be configured to provide fire/heat resistance and/or may make the cover 120 (and the fluid conduit 16 that the cover 120 is disposed around) generally fireproof.

Embodiments of fireproof covers 20, 120 may be applied to a wide variety of components, such as fluid conduits/conveying products that may require fireproofing, including, without limitation, aerospace conveyance products (e.g., a fireproof hoses/conduit 16 and/or a coupling 12). Embodiments of fireproof covers 20, 120 described in the present disclosure may meet AS1055 and/or TSO requirements.

Embodiments of covers 20, 120 may perform favorably compared to silicone covers. For example and without limitation, silicone covers may not be able compatible with 15 minute AS1055 and TSO no-flow performance requirements. By contrast, embodiments of covers 20, 120, which may include a plurality of insulating layers, may be able to meet the requirements consistently.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. A fireproof cover for fluid conveyance products, comprising:
an inner layer including a first polymer;
an intermediate layer including a thermally insulating material; and
an outer layer including a second polymer.

2. The fireproof cover of claim 1, wherein the first polymer is silicone and the inner layer is configured as a molded silicone layer.

3. The fireproof cover of claim 2, wherein the intermediate layer is a silica sleeve disposed at least partially between the inner layer and the outer layer; and the outer layer includes silicone and graphite.

4. The fireproof cover of claim 3, including a second intermediate layer; wherein the second intermediate layer includes basalt; and the second intermediate layer is disposed at least partially between the intermediate layer and the outer layer.

5. The fireproof cover of claim 4, wherein the intermediate layer is disposed in contact with an outer surface of the inner layer; the second intermediate layer is disposed in contact with an outer surface of the intermediate layer; and the outer layer is disposed in contact with an outer surface of the second intermediate layer.

6. The fireproof cover of claim 5, wherein a radius of the inner layer is smaller than a radius of the outer layer.

7. The fireproof cover of claim 1, wherein at least one of the inner layer, the intermediate layer, and the outer layer includes alumina trihydrate, magnesium hydroxide, and/or an engineered molybdate compound.

8. The fireproof cover of claim 1, wherein the inner layer, the intermediate layer, and the outer layer are flexible.

9. The fireproof cover of claim 1, including a wire braiding layer disposed at an inner surface of the inner layer.

10. The fireproof cover of claim 1, including one or more additional intermediate layers disposed at least partially between the inner layer and the outer layer.

11. The fireproof cover of claim 10, wherein the intermediate layer includes fiberglass; the intermediate layer is disposed at an outer surface of the inner layer; and at least one of the one or more additional intermediate layers includes basalt.

12. The fireproof cover of claim 10, wherein the intermediate layer includes fiberglass; the one or more additional intermediate layers include (i) a first layer of basalt tape wrapped around the intermediate layer, (ii) a layer of fiberglass wrapped around the first layer of basalt tape, and (iii) a second layer of basalt tape wrapped around the layer of fiberglass; and the outer layer is disposed at an outer surface of the second layer of basalt tape.

13. The fireproof cover of claim 10, wherein the one or more additional intermediate layers includes three layers.

14. A fluid conduit assembly, comprising.
a fluid conduit; and
the fireproof cover of claim 1;
wherein the inner layer is connected with an outer surface of the fluid conduit.

15. The fluid conduit assembly of claim 14, wherein the fluid conduit and the fireproof cover are flexible.

16. The fluid conduit assembly of claim 14, wherein the fluid conduit with the fireproof cover is compliant with AS1055.

17. The fluid conduit assembly of claim 14, wherein a thickness of the fireproof cover is greater than half of a diameter of the fluid conduit and less than the diameter of the fluid conduit.

18. The fluid conduit assembly of claim 14, wherein the fireproof cover is formed directly onto the fluid conduit.

19. An assembly, comprising:
the fluid conduit assembly of claim 14; and
a fluid coupling connected to the fluid conduit assembly.

20. The assembly of claim 19, wherein the fireproof cover covers and thermally insulates at least a portion of the fluid coupling.
